(19) United States
(12) Patent Application Publication
(10) Pub. No.: US 2006/0118980 A1
(43) Pub. Date: Jun. 8, 2006

(54) Apparatus and method of producing dope

(75) Inventors: Akira Yamada, Kanagawa (JP); Yukihiro Katai, Kanagawa (JP); Takuro Nishimura, Kanagawa (JP); Tadahiro Tsujimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/290,397

(22) Filed: Dec. 1, 2005

(30) Foreign Application Priority Data
Dec. 7, 2004 (JP) 2004-353519

(51) Int. Cl. B29C 47/60

(52) U.S. Cl. 264/28; 264/211.23; 425/204

(57) ABSTRACT

A stock solution is prepared by mixing and swelling TAC as a solute in a solvent, and is fed into an extrusion machine. The extrusion machine is cooled by a cooling medium, and is provided with twin-shaft screws. The screws are a compressing type where thread pitches of a helical flight decrease toward downstream. The screws are in mesh with each other and rotated in the same direction. Through the extrusion machine, the solute is dissolved in the solvent to form a dope. The dope is further cooled in a cooler to promote the solubility of the dope. Thereafter, the dope is heated by a heater to raise the fluidity. From the obtained dope, TAC film with excellent optical properties may be formed by a solution casting method.

### BACKGROUND OF THE INVENTION

1. Field of the Invention

The present invention relates to an apparatus and a method of producing a dope.

2. Description Related to the Prior Art

Polymers have been used in many fields, for manufacturing many products in several methods depending on use thereof. For example, plastic film or the like is produced in a melt extrusion method in which polymer is heated and melted, or in a solution casting method in which the polymer is dissolved or dispersed in an organic solvent to prepare a solution, hereinafter referred to as a dope. In the solution casting method, the dope is cast on a substrate to volatilize the solvent, and thus the film is produced. The solvent to be used is selected so as to be adequate in consideration of several points, such as solubility of the polymer, volatility, influences on human bodies and circumstances, and the like. Among all, safety to the human bodies and the circumstances are strongly required these days. Therefore, selection of suitable solvent for preparing the dope becomes harder in relation to some sorts of polymers.

For example, when cellulose acetate film which is often used as a photographic film base is produced from cellulose acetate, hereinafter called TAC including cellulose triacetate or triacetyl cellulose, chlorinated methylenes (methylene chloride, dichloromethane) are used as a main solvent in the solution casting method. Because the TAC film is superior in optical isotropy, it has also been used as optical function film such as polarizing plate protector film, as described in Japan Institute of Invention and Innovation (JIII) JOURNAL 2001-1745. However, the use of the methylene chloride tends to be strictly limited, because it has influences on the human bodies and the circumstances. As alternative solvents, acetic acid methyl and acetone have been suggested. Although acetic acid methyl and acetone have less problems toward human bodies and the environment, these materials cannot easily dissolve TAC.

In view of the foregoing, a method of producing the dope necessary for the solution casting is suggested for example in Pub. No. US 2003/0185925, wherein a cooling dissolving apparatus utilizes a screw mixer or screw extruder. In followings, the method of preparing the dope by cooling the solvent containing the polymer is called “Cool-dissolving method”. The cool-dissolving method enables continuous production of dopes by cooling a screw extruder as a dope producing machine.

In the cooling dissolving method, materials containing TAC and a solvent are cooled down to a predetermined temperature and kept at this temperature for a predetermined time to ensure solubility. To adopt this method to a dope producing process, the cooled screw extruder is useful because it can send viscous liquids and has a high heat exchange efficiency. As for the screw extruder, the dope stays in the screw for a time that is determined by length, diameter and rotational number of the screw, so the upper limit of processing amount depends on the shape of the screw. To raise the maximum processing amount, it is necessary to enlarge the extruder or increase the number of installed extruders, which increases the cost. Therefore, on designing a dope production process, it is important to investigate an extruder that is as small as possible, can achieve required performances with less number, and improves cooling efficiency. In addition, if the dope is insufficiently mixed, the dope will have temperature distribution at the exit of the screw extruder, bothering stability in sending the dope as well as solubility of the dope.

### SUMMARY OF THE INVENTION

In view of the foregoing, a primary object of the present invention is to provide an apparatus for producing a dope, which is improved in cooling efficiency and kneading function to produce a homogenized dope. The present invention is also made to provide an efficient dope production method.

The inventors of the present invention have found that heat exchanging efficiency between the materials of the dope and the cooling medium is improved by use of an extrusion machine that is provided with a multi-shaft screw device as it is superior in kneading properties. Promoting heat exchanging efficiency leads to improving cooling efficiency and thus solubility of the solutes such as polymers. Kneading the materials with the multi-shaft screw device suppresses temperature distribution, reduces unevenness in solubility and thus reduces temperature unevenness. As a result, homogeneity of the dope is improved. It has also been found that the solubility of the dope is promoted by elongating cooling time that is achieved by disposing a cooling device at the exit of the extrusion machine. Furthermore, cooling the screws themselves increases heat transmission area between the stock solution of the dope and the cooling medium, so the cooling performance is improved.

According to the present invention, an apparatus for producing a dope by sending materials of the dope through an extrusion machine, the extrusion machine comprising:
a cylinder to which the materials are supplied through an entrance, the dope being sent out from an exit of the cylinder;
a multi-shaft screw device comprising a number of screws, each of the screws being rotatably disposed in the cylinder; and
a first cooling device for cooling the materials.

The dope producing apparatus is excellent in cooling properties and solution sending properties, so the obtained dope is excellent in homogeneity and solubility.

According to a preferred embodiment, the multi-shaft screw device comprises two screws, and the two screws are in mesh with each other and rotated in the same direction.

This configuration increases shearing force to the dope materials, and thus promote the solubility.

Each of the screws preferably has a diameter D(mm) and a pitch P(mm) that is at a ratio (P/D) of 0.3 to 1.5 relative to the diameter D.

According to this embodiment, the shearing force and rotational number of the screws are optimized, suppressing shearing heat that increases with an increase in rotational number of the screws.

The ratio (P/D) of the pitch P to the diameter D preferably decreases in a solution sending direction from the entrance toward the exit of the cylinder.

According to this configuration, the dope materials are compressed by the screw device, so the solubility of solutes, especially polymer, of the dope materials is improved.

According to a preferred embodiment, the first cooling device is a jacket provided on a periphery of the cylinder, a cooling medium being supplied into the jacket. The jacket is preferably divided into at least two sections in the solution sending direction.

It is preferable to provide a second cooling device for cooling the screws. Cooing the screws themselves contributes to improving heat exchanging efficiency of the dope materials, and thus the homogeneity and the solubility of the dope. The second cooling device preferably comprises cooling medium conducting channels formed through respective shafts of the screws and a device for supplying a cooling medium to the cooling medium conducting channels. This enables cooling the screws without enlarging the scale of the extrusion machine. At least one of the first and second cooling devices comprises a dual freezer that cools the cooling medium. In that case, the dual freezer cools the cooling medium in an indirect cooling method that reduces temperature distribution of the cooling medium.

According to a further preferred embodiment, a third cooling device for cooling the dope is provided on a downstream side of the extrusion machine. The third cooling device elongates the cooling time with each. It is also preferably to dispose a heating device for heating the dope on a downstream side of the third cooling device. The cooling mediums used in the first to third cooling devices are at least one of methanol, dichloromethane, hydro-fluoro-ether and fluorocarbon.

A method of producing a dope of the present invention comprises steps of: feeding materials of the dope, including a polymer and a solvent, to an extrusion machine having a plurality of screws; compressing the materials or the dope by the screws; and cooling the materials or the dope while being sent through the extrusion machine.

It is preferable to compress the materials or the dope by decreasing pitches P (mm) of each of the screws in a solution sending direction through the extrusion machine.

The materials or the dope is preferably cooled at a cooling speed of 5° C./minute to 200° C./minute, so as to extrude the dope from the extrusion machine at a temperature of −30° C. or less.

Where the materials or the dope is cooled by supplying a cooling medium into a jacket that is provided on a periphery of a cylinder of the extrusion machine, the jacket is preferably divided into at least two sections in the solution sending direction, and the cooling medium is set at a first temperature T1(° C.) on an upstream side and at a second temperature T2(° C.) on a downstream side in the solution sending direction, wherein T2<T1.

It is preferable to cool the screws. It is also preferable to cool the dope further in a cooler after the dope is extruded from the extrusion machine, preferably at most for 60 minutes. The cooler is supplied with a cooling medium whose temperature T3(° C.) is preferably defined to satisfy the following condition relative to a temperature T(° C.) of the dope at an exit of the extrusion machine: T−30° C.≦T3≦T+30° C.

The polymer is preferably cellulose acylate, more preferably cellulose acetate, and most preferably cellulose triacetate. A film formed from the dope obtained in this way is superior in optical properties. The solvent preferably includes at least methyl acetate that is superior in view of environmental protection.

The present invention includes the dope produced according to the above-described dope producing method. The present invention further includes a solution casting method using the above-described dope, which includes co-casting, sequential casting and sequential co-casting. The present invention also includes a film formed in said solution casting method. The present invention further includes using said film as a protective film of a polarizing plate, and a polarizing plate using said protective film. The present invention includes an optical compensation film constituted of said inventive film, as well as a liquid crystal display device constituted of said polarizing plate and said optical compensation film.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is a schematic diagram of a dope producing apparatus embodying the present invention;

FIG. 2 is a sectional view of an extrusion machine used in the dope producing apparatus of FIG. 1;

FIG. 3 is an explanatory diagram illustrating a screw used in the extrusion machine of FIG. 2;

FIG. 4 is a schematic diagram illustrating a couple of screws used in the extrusion machine;

FIG. 5 is a sectional view of the extrusion machine of FIG. 4;

FIG. 6 is a sectional view of an extrusion machine according to another embodiment of the present invention;

FIG. 7 is a schematic diagram illustrating an equipment for producing a film in a solution casting method;

FIG. 8 is a fragmentary sectional view of an essential part of another equipment for producing a multi-layered film in a co-casting method;

FIG. 9 is a schematic diagram illustrating an essential part of a further equipment for producing a multi-layered film in a co-casting method; and

FIG. 10 is a fragmentary sectional view of an essential part of another equipment for producing a multi-layered film in a sequential solution casting method.

### PREFERRED EMBODIMENTS OF THE INVENTION

Preferred embodiments of the present invention will now be described in detail, but the present invention is not to be limited to the following embodiments.

[Raw Material]

In the present embodiment, cellulose acylates are used as polymers. As a cellulose acylate, triacetyl cellulose (TAC) is particularly preferable. Among cellulose acylates, ones satisfying all of the following conditions (I), (II) and (III) with respect to acyl substitution degree for hydrogen atoms of hydroxyls in cellulose are more preferable. In the following conditions (I) to (III), SA and SB represent substitution degrees of acyls for hydrogen atoms of hydroxyls of cellulose, wherein SA represents a substitution degree of acetyls, whereas SB represents a substitution degree of acyls whose carbon atomicity is 3 to 22. It is preferable that not less than 90% by mass of TAC consist of particles of 0.1 mm to 4 mm.
2.5≦SA+SB≦3.0
0≦SA≦3.0
0≦SB≦2.9

It is to be noted that the polymers usable in the present invention are not limited to cellulose acylates.

Glucose units in β-1,4 linkage, which constitute cellulose, have hydroxyls released in second, third and sixth sites. Cellulose acylates are polymers obtained by esterifying these hydroxyls partly or wholly by acyls whose carbon number is not less than 2. The acyl substitution degrees means respective percentages of esterification of the hydroxyls released in the second, third and sixth sites in cellulose. For example, substitution degree “1” means 100% of esterification.

The total of the substitution degrees by acylation, DS2+DS3+DS6, is preferably 2.00 to 3.00, and more preferably 2.22 to 2.90, and particularly 2.40 to 2.88. It is preferable to set DS6/DS2+DS3+DS6 at a value of not less than 0.28, more preferably not less than 0.30, and most preferably from 0.31 to 0.34, wherein DS2 represents the substitution degree of acyls for hydroxyls of the second site in glucose unit, hereinafter referred to as acyl substitution degree in the second site, wherein DS3 represents the substitution degree of acyls for hydroxyls of the third site, hereinafter referred to as acyl substitution degree in the third site, and DS6 represents the substitution degree of acyls for hydroxyls of the sixth site, hereinafter referred to as acyl substitution degree in the sixth site.

In the present invention, a single acyl group or plural acyl groups may be used in cellulose acylate. In a case where a plurality of acyl groups are used, one of these acyl groups is preferably acetyl group. Provided that DSA represents the total of the substitution degrees for hydroxyls in the second, third and sixth sites, and DSB represents the total of the substitution degrees of other acyl groups than acetyl groups for hydroxyls in the second, third and sixth site, the value DSA+DSB is preferably 2.22 to 2.90, and more preferably 2.40 to 2.88, wherein DSB is not less than 0.30 and preferably not less than 0.7. Moreover, of the total DSB, substituents for hydroxyls of the sixth site take up not less than 20%, preferably not less than 25%, more preferably not less than 30%, and most preferably not less than 33%. Furthermore, such cellulose acylates may be mentioned as preferable, whose substitution degree in the sixth site is not less than 0.75, more preferably not less than 0.80, and most preferably not less than 0.85. With these cellulose acylates, a dope preferable in solubility can be produced. Particularly with non-chlorine organic solvent, it becomes possible to produce a solution or dope that is less viscous and well filtrating.

Celluloses as a raw material of the cellulose triacetate may be those obtained from either cotton linters or cotton pulps, but those obtained from cotton linters are preferable.

The acyls of the cellulose acylate of the present invention, whose carbon number is not less than 2, maybe aliphatic radicals or aryl radicals, and are not particularly limited. For example, the acyls may be alkyl-carbonyl-ester, alkenly-carbonyl-ester, aromatic carbonyl-ester or aromatic alkyl-carbonyl-ester of the celluloses, and may have substitutents of these esters respectively. As preferable examples of such substitutents, propionyl, butanoyl, pentanoyl, hexanoyl, octanoyl, decanoyl, dodecanoyl, tridecanoyl, tetradecanoyl, hexadecanoyl, octadecanoyl, iso-butanoyl, t-butanoyl, cyclohexane carbonyl, oleoyl, benzoyl, naphthyl carbonyl and cinnamoyl may be mentioned. Among these, propionyl, butanoyl, dodecanoyl, octadecanoyl, t-butanoyl, oleoyl, benzoyl, naphthyl carbonyl and cinnamoyl are more preferable, and propionyl and butanoyl are particularly preferable.

As the solvent for producing the dope, aromatic hydrocarbons (benzene, toluene and the like), halogenated hydrocarbons (dichloromethane, chlorobenzene and the like), alcohols (methanol, ethanol, n-propanol, n-butanol, diethylene glycol and the like), ketones (acetone, methyl-ethyl-ketone and the like), esters (methyl acetate, ethyl acetate, propyl acetate and the like), and ethers (tetrahydrofuran, methyl cellosolve and the like). In the present invention, the dope means a polymer solution or dispersion liquid obtained by dissolving or dispersing the polymers in the solvent.

Among these solvents, halogenated hydrocarbons with carbon atomicity of 1 to 7 are preferable, and dichloromethane is the most preferable. In view of solubility to TAC, removability of the cast web from the substrate, mechanical strength and optical properties of the film and other physical properties of the film, it is preferable to mix at least one alcohol with carbon atomicity of 1 to 5 in addition to dichloromethane. The content of the alcohol or alcohols is preferably 2 wt % to 25 wt % of the total solvents, and more preferably 5 wt % to 20 wt %. As concrete examples of such alcohols, methanol, ethanol, n-propanol, iso-propanol and n-butanol may be mentioned, among of which methanol, ethanol, n-butanol and mixtures of these components are preferable.

Recently, for the purpose of suppressing influence on environments to the minimum, studies have been made for composing solvents without dichloromethane, and it has been found that ethers whose carbon atomicity is 4 to 12, ketones whose carbon atomicity is 3 to 12, esters whose carbon atomicity is 3 to 12, and alcohols whose carbon atomicity is 1 to 12 are preferably used for this purpose. It is possible to mix these components appropriately. For example, a mixture of methyl acetate, acetone, ethanol and n-butanol may be mentioned as the solvent. For this purpose, the ethers, ketones, esters and alcohols may have ring structures. Compounds with any two or more of functional groups of ether, ketone, ester and alcohol, i.e. —O—, —CO—, —COO— and —OH, may be used as the solvent.

Details on the cellulose acylates are described in Japanese Patent Application No.2005-104148, paragraphs [0141] to [0192]. The description there may apply to the present invention. Details on the solvents and the additives, such as plasticizers, anti-deterioration agents, ultraviolet stabilizer, optical anisotropy controllers, retardation controllers, dye stuffs, matting agents, release agent and release accelerant, are also described in Japanese Patent Application No. 2005-104148, paragraphs [0193] to [0513].

[Swelling Process]

In the swelling process, the polymers are mixed with the solvent so as to swell therein. The temperature in the swelling process is preferably set from −10° C. to 55° C., and usually at a room temperature. The rate of the polymers to the solvent is determined according to the density of the dope to obtain finally. Usually, the preferable density of the polymers is from 5 wt % to 30 wt % of the dope, more preferably from 8 wt % to 20 wt %, and most preferably from 10 wt % to 15 wt %. It is preferable to stir the mixture of the swollen polymer and the solvent for 10-150 minutes, particularly 20-120 minutes, such that the polymers may swell enough. In the swelling process, other components than the polymer and the solvent, for example, plasticizers, anti-deterioration agents, ultraviolet stabilizers may also be added.

[Dope Production Apparatus]

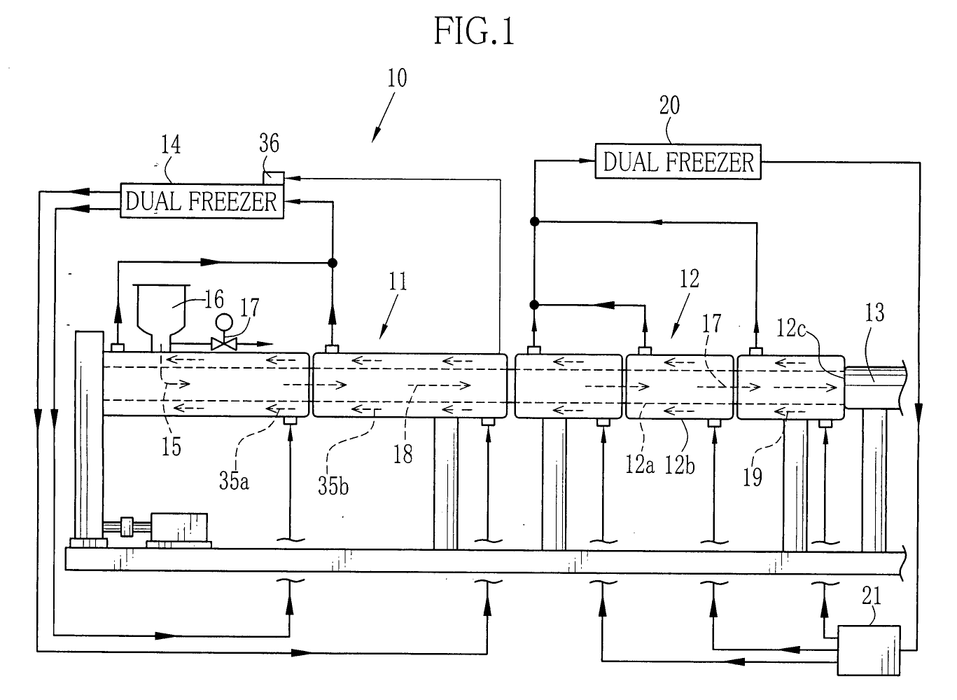

FIG. 1 illustrates a dope production apparatus 10 used in a method of preparing a dope. In the dope production apparatus 10, there are an extrusion machine 11, a cooler 12 and a heater 13. Further, a dual freezer 14 for supplying a cooling medium is connected to the extrusion machine 11. A hopper 16 with a volumetric feeder is also attached to the extrusion machine 11. Into the hopper 16 are supplied materials of the dope or a solution obtained in the above-mentioned swelling process, hereinafter both will be commonly referred to as the stock solution 15. A pressure control valve 17 is attached to the hopper 16. The raw materials of the dope are solutes, including the above mentioned polymers and additives as being added if necessary, and the above mentioned solvent (it may be mixture solvent). The swelling solution is made of these raw materials through the above described swelling process. In the following description, the solution 15 contains the TAC as the polymer, and the solvent contains methyl acetate as the main solvent (composition ratio of the methyl acetate is 30 wt % to 98 wt %). However, the composition of the stock solution 15 is not restricted to this embodiment.

[Cool-Dissolving Process]

The stock solution 15 is fed from the hopper 16 into the extrusion machine 11. Then the stock solution 15 is kneaded while being cooled and compressed, thereby to produce the dope 18. Note that in the present invention, the stock solution 15 refers to the raw materials for preparing the dope and includes the solution obtained by the swelling process, and the dope 18 refers to a condition where the solute is dissolved or dispersed in the solvent of the stock solution 15. A condition where the solute is partly dissolved in the solvent, may be referred to either as the stock solution 15 or as the dope 18. Unless a particular explanation is made, the solute is assumed to be partly dissolved in the solvent in the extrusion machine 11. The volumetric feeder may be a rotary pump or a gear pump, but may be another device. By controlling opening degree of the pressure control valve 17, the stock solution 15 may be fed into the extrusion machine 11 at a constant pressure, enabling making the dope homogeneous.

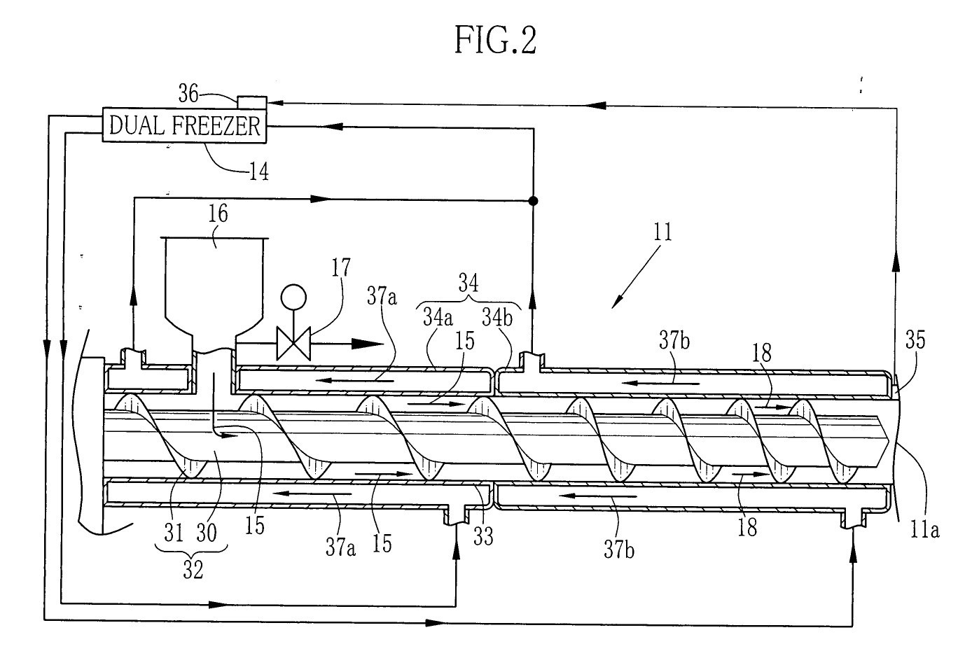

As shown in FIG. 2, the extrusion machine 11 includes a cylinder 33 and a screw 32 provided in the cylinder 33. The screw 32 has a screw shaft 30 and a flight 31 formed to the screw shaft 30. Around a periphery of the cylinder 33, a jacket 34 is provided. In the present invention, in order to control the temperature of the stock solution 15 or the dope 18 in the cylinder 33, the jacket 34 is parted into several sections, i.e. two sections 34a and 34b in the illustrated embodiment. This configuration is preferable as making it possible to control the temperature of the cylinder 33 so as to feed the stock solution 15 or the dope 18 effectively. When the temperature of the cylinder 33 is controlled, the feeding conditions of the stock solution 15 or the dope 18 are adequately adjusted, which improve the productivity of the dope 18. In FIG. 2, there are a first section 34a on the entrance side and a second section 34b on the exit side. However, a jacket having more than two sections may be used in the present invention.

A thermometer 35 is attached to an exit 11a of the extrusion machine 11 for measuring the temperature T(° C.) of the dope 18 at the exit 11a. On the basis of the data of the measurement, a controller 36 controls the dual freezer 14 such that the temperature of the dope 18 maybe the most adequate. For example, the dope exit temperature T is preferably −30° C. However, in the present invention, the temperature T may be controlled according to the composition of the stock solution 15. Further, the control of the temperature is not restricted to the automatic control by the controller 36, but an operator may read the measured value of the thermometer to manually change the dope temperature adequately at the exit.

Cooling mediums 37a and 37b are respectively feed through the first and second sections 34a, 34b of the jacket 34 to cool the cylinder 33, thereby to cool the stock solution 15 or the dope 18 in the cylinder 33. The cooing mediums 37a and 37b are not restricted especially, but it may be methanol, hydro-fluoro ethers, fluoro carbons, brine (trade name) and the like. Note that in the present invention, the temperature of the cooling mediums 37a and 37b fed through the jacket 34 is regarded as the temperature of the jacket 34, and thus regarded as the temperature of the stock solution 15 or the dope 18.

In the present invention, a cooling speed of the stock solution 15 or the dope 18 in the extrusion machine 11 is preferably in the range of 5° C./min to 200° C./min. The cooling speed in the extrusion machine 11 is calculated by a temperature T0(° C.) of the stock solution 15 as supplied into the cylinder 33, the above mentioned dope exit temperature T (° C.), a flowing time Tc(minute) of the stock solution 15 or the dope 18 throughout the extrusion machine 11. Concretely, the cooling speed is calculated by the formula: (T−T0)/Tc. If the cooling speed is below 5° C./min, the stock solution 15 is cooled so slowly that it takes much time for preparing the dope 18, resulting in raising the cost. Above 200° C./min, sudden falling of the temperature may cause such troubles that the stock solution 15 is partially solidified in the cylinder 33, damaging uniformity or homogeneity of the dope 18.

A feeding speed of the cooling mediums 37a and 37b is preferably controlled in the range of 0.1 m/s to 50 m/s, in order to cool the cylinder 33 adequately for cooling the stock solution 15 or the dope 18 uniformly in the cylinder 33. However, the cooling mediums 37a and 37b are not restricted in the above feeding speed. Note that in view of the cooling efficiency, it is preferable to feed the cooling mediums 37a and 37b in an opposite direction to the feeding direction of the stock solution 15 or the dope 18, as shown in the drawing. However, the cooling mediums may be fed in the same direction as the stock solution 15 or the dope 18.

The temperature T1(° C.) of the first section 34a of the jacket 34, i.e. the temperature T1 on the entrance side of the cylinder 33, is set higher than the temperature T2(° C.) of the second section 34b of the jacket 34, i.e. the temperature T2 on the exit side of the cylinder 33: T2<T1. This permits cooling the stock solution 15 moderately while the solute such as the polymer is not dissolved in the solvent, and thus facilitates feeding the solution. After the dissolution is progressed and the feeding becomes easier, that is, after most of the stock solution 15 becomes the dope 18, the cooling temperature is set lower to improve the solubility. Concretely, the temperature T1 at the entrance of the cylinder is in the range of −30(° C.) to 5(° C.), and the temperature T2 at the exit of the cylinder 33 is in the range of −100(° C.) to −30(° C.). However, the cooling temperatures are not to be limited to these ranges.

After flowing through the first and second sections 34a and 34b of the jacket 34, the cooling mediums 37a and 37b are fed to the dual freezer 14. The dual freezer 14 cools the cooling mediums 37a and 37b again to desirable temperatures. The dual freezer 14 will be described in detail later. The cooled cooling mediums 37a and 37b are fed again into the first and second sections 34a and 34b. Since the cooling mediums 37a and 37b are circulated, they are not discharged into the atmosphere, and therefore have no influences on the environment, and also saves the cost. However, the present invention is not to be limited to the method where the cooling mediums 37a and 37b are circulated for reuse. Although the embodiment shown in FIG. 2 use only one freezer 14, it is possible to connect two freezers to the first and second sections 34a and 34b respectively. It is not always necessary to divide the jacket for the sake of temperature control, but a jacket without any partition is usable. A jacket divided into three or more sections is also usable.

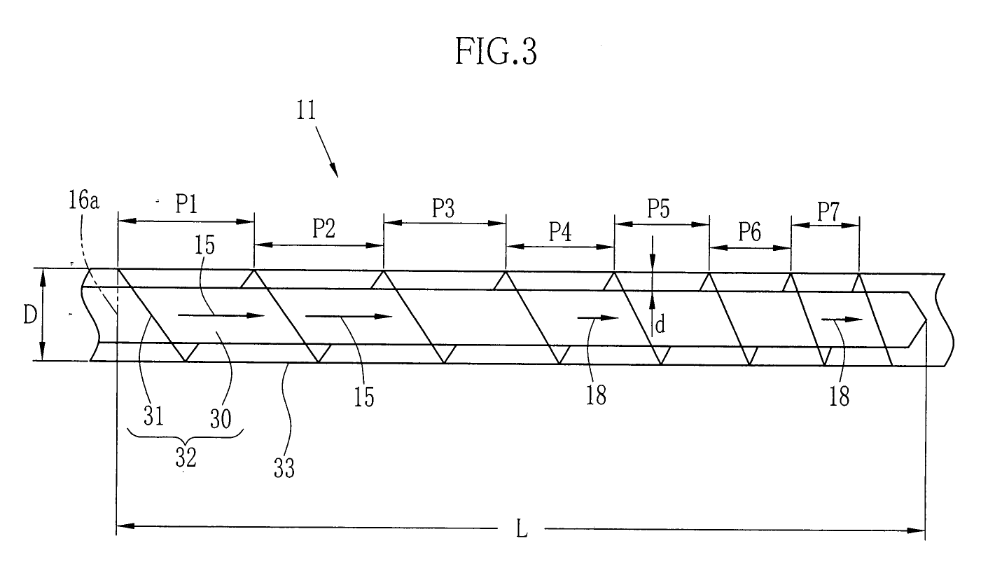

FIG. 3 shows the screw 32 used in the dope producing apparatus 10 of the present invention. In FIG. 3, D(mm) designates a diameter of the screw 32, and P1, P2, P3, P4, P5, P6 and P7 designate pitches (mm) of the flight 31. The pitches P1 to P7 decrease in the feeding direction of the stock solution 15 or the dope 18, and correspond to lead lengths of the screw 32 if the flight 31 is a single-thread type. Concretely, P1≧P2≧P3≧P4≧P5≧P6≧P7 and P1>P7. Because of this configuration, the stock solution 15 is compressed as it flows through the cylinder 33, thereby promoting the solubility of the solutes. The number of threads of the flight 31 is not limited to seven, but may preferably be from 6 to 150, more preferably from 15 to 120, and most preferably from 37 to 60. The flight 31 is not limited to the single-thread type, but may be a double-thread type.

Where the pitches P1 to P7 of the flight 31 are small, the screw 32 must turn with a large rotational number (at a high peripheral velocity) to deal with the same amount of stock solution 15. As the peripheral velocity increases, the screw 32 is improved in heat transmission coefficient, but it can lower efficiency of cooling due to shearing heat. Accordingly, the peripheral velocity is preferably from 0.20 m/s to 0.40 m/s, with respect to a twin-shaft screw.

Ratios Rn of the pitches P1 to P7(mm) to the screw diameter D(mm), wherein “n” represents a serial number of each thread in the order from the solution entrance, hereinafter referred to as the pitch ratio Rn=P/D, are preferably from 0.3 to 1.5, more preferably from 0.5 to 1.0, and most preferably from 0.7 to 0.8. In addition to that, the pitch ratio R1 of the thread at the solution entrance and the pitch ratio R7 of the thread at the dope exit preferably have a relationship: 1<(R1/R7)≦10, more preferably 1≦(R1/R7)≦5, and most preferably 2≦(R1/R7)≦3. If (R1/R7) is less than 1, it is hard or impossible to obtain the effect of compressing the solution. If (R1/R7) is over 10, solution sending pressure becomes too large and undesirable.

Further, the ratio (L/D) of a length L(mm) of a leading portion of the screw 32 to the screw diameter D(mm) is preferably set at a value from 5 to 100. More preferably 20<(L/D)<100 (the lead is from 0.30 mm to 1.5 mm), and still more preferably 50<(L/D)<80 (the lead is from 0.30 mm to 1.5 mm or 0.75 mm). Although it is possible to use a single screw and a single cylinder, it is preferable to use the screw and the cylinder which have segment structures consisting of a plurality of members, because of convenience in changing the members in troubles or the like. As materials of the screw 32 and the cylinder 33, SCM (chrome molybdenum steel) and nitrides thereof are preferable in view of resistance to corrosion and cold shock, high thermal conductance and workability. SUS is also usable as the materials of the screw 32 and the cylinder 33.

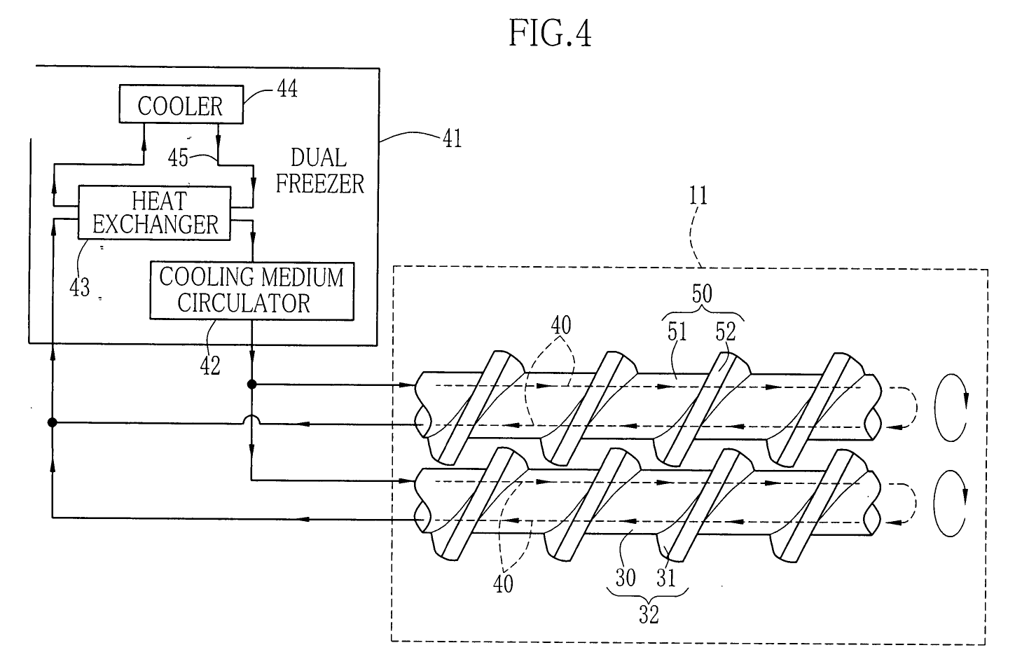

The extrusion machine 11 of the present invention is provided with a number of screws. FIG. 4 shows an embodiment having two screws 32 and 50, wherein the screw 50 has a screw shaft 51 and a flight 52, and is configured to satisfy the same conditions as the screw 32. Although the present invention will be described with reference to the twin-screw extrusion machine 11, the extrusion machine may have three or more screws. In that case, individual screws are configured in the same way as the screw 32 shown in FIGS. 2 and 3. Using the multi-screw extrusion machine, performance of kneading the stock solution 15 or the dope 18 is improved. The screw extrusion machine is suitable for cool-sending of the dope 18 in the dope producing apparatus, because it is excellent in cooling property as well as in solution sending property. Therefore, the stock solution 15 is cooled and compressed while it is being sent through the cylinder, promoting the solubility of the solutes in the solvent. Consequently, the solutes are completely dissolved in the solvent in the obtained dope.

In order to apply good shearing to the stock solution and the dope 18, it is preferable to rotate the screws 32 and 50 in the same direction, but the screws 32 and 50 may rotate in opposite directions. For the sake of shearing the stock solution and the dope 18, the screws 32 and 50 preferably mesh with each other. That is, the flight of one screw is in mesh with the groove of another screw, to scrape the sending fluid out of the groove, providing a self-cleaning effect that reduces residue of the sending fluid. This configuration allows sending the stock solution 15 or the dope 18 without over-cooling or temperature unevenness. The screws may partly or completely mesh with each other. But as the degree of meshing the screws is greater, the self-cleaning effect gets bigger, so the stability of sending the stock solution 15 or the dope 18 is improved. Note that the screws 32 and 50 partly mesh with each other in FIG. 4.

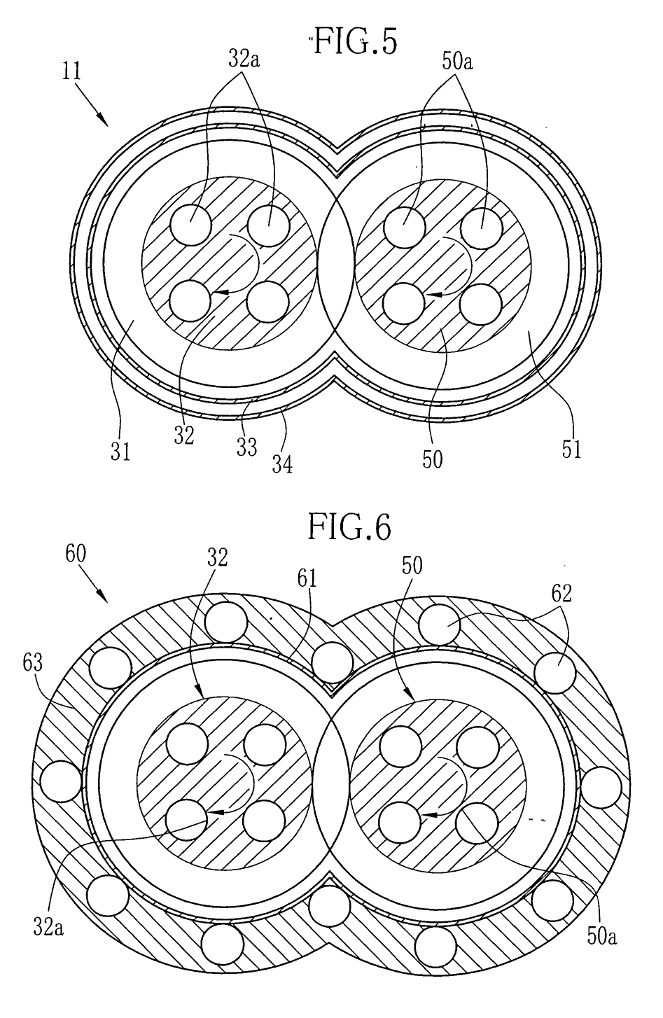

According to a preferred embodiment of the present invention, the screws 32 and 50 are also cooled. Cooling the screws 32 and 50 raises the cooling efficiency of the stock solution or the dope 18 remarkably, i.e. the cooling efficiency is almost doubled. So the solubility of the solutes, especially the polymers, in the stock solution is well improved. As shown in FIG. 5, channels 32a and 50a are formed inside the screws 32 and 50 along their axial direction, for feeding a cooling medium 40 through these channels 32a and 50a.

The cooling medium 40 is preferably supplied from a dual freezer 41, as shown in FIG. 4. The dual freezer 41 is constituted of a cooling medium circulator 42, a heat exchanger 43 and a cooler 44. The cooling medium circulator 42 supplies the cooling medium 40 to the channels 32a and 50a inside the screws 32 and 50, and the cooling medium 40 is fed back from the screws 32 and 50 to the heat exchanger 43 of the dual freezer 41. The heat exchanger is supplied with a second cooling medium 45 from the cooler 44, so the cooling medium 40 is cooled down to a desirable temperature, e.g. −90° C. to 25° C., by exchanging heat energy between the cooling medium 45. Thereafter the cooling medium 40 is supplied again through the cooling medium circulator to the channels 32a and 50a. Using the dual freezer 41, which cools the cooling medium 40 in the above-described indirect cooling method, is preferable because it is effective to keep the temperature of the cooling medium 40 constant. Note that the dual freezers 14 and 20 preferably have the same structure as the dual freezer 41. The second cooling medium 45 is not particularly designated, but preferably R13, R404A, CO₂ or ammonia.

As shown in FIG. 5, the cylinder 33 covers up the screws 32 and 50, and the jacket 34 surrounds the cylinder 33. As the stock solution 15 flows through a gap between the screws 35 and 50 and the cylinder 33, the stock solution 15 is compressed and the polymers are dissolved in the solvent to form the dope 18.

FIG. 6 shows a sectional view of an extrusion machine 60 according to another embodiment of the present invention, wherein screws 32 and 50 are configured in the same way as the extrusion machine 11. The screws 32 and 50 are mounted in a cylinder 61, and a drill jacket 63 formed with internal channels 62 for conducting a cooling medium is mounted around the cylinder 61. The channels 62 extend from end to end of the drill jacket 63, and the cooling medium conducted through the channels 62 will cool the cylinder 61. The drill jacket 63 is advantageous because it elongates the distance through which the cooling medium flows.

[Low Temperature Keeping Process]

It is preferable to feed the dope 18 as cooled in the extrusion machine 11 to the cooler 12, for further dissolution of the dope 18. The cooler 12 is a double pipe type that is provided with an inner pipe 12a and an outer pipe 12b, which reduces the feeding resistance of the dope 18. The outer pipe 12b is preferably divided into plural sections. In FIG. 1, the outer pipe 12b is separated into three sections, such that the temperature control can be independently made in each section. The cooling medium 19 is fed through the outer pipe 12b to cool the dope 18 in the inner pipe 12a. Since the cooler 12 elongates the cooling time of the dope 18, the solubility of the dope 18 is promoted, so that the dope 18 is obtained in the well homogenized condition. To improve the productivity, the cooling time of the dope 18 in the cooler 12 is preferably from 10 minutes to 60 minutes. If the cooling time by the cooler 12 is less than 10 minutes, the effect of elongating the cooling time on promoting the solubility can be insufficient. When the cooling time is longer than 60 minutes, the solubility is not promoted so much, that it can be disadvantageous in view of the cost. However, the cooling period may be more than 60 minutes depending on the composition of the stock solution 15.

The cooling medium 19 discharged from the cooler 12 is fed to the dual freezer 20, to cool the cooling medium 19 again. The cooling medium 19 is fed through a branching pipe 21 back to the outer pipe 12b. Therefore, the required amount of the cooling medium 19 is reduced, and the cooling medium 19 is little discharged in the circumstance, which is desirable in view of the environmental protection. The cooling medium 19 used in the present invention is preferably methanol, dichloromethane, hydrofluoroethers, fluoro-carbon, cold brine (trade name), and the like, and most preferably Novec (trade name) which is one of hydrofluoro ethers. It is not always necessary to provide the dual freezers 14 and 20 respectively for the extrusion machine 11 and the cooler 12, but only one dual freezer or cooler may be used for cooling the cooling medium.

The cooling medium 19 as fed to the cooler 12 is set at a temperature T3(° C.) that is defined relative to the dope exit temperature T(° C.) at the exit 11a of the extrusion machine 11, such that T3 is not less than (T−30)° C. and not more than (T+30)° C. If the temperature T3 is lower than (T−30)° C., the dope 18 is further cooled so rapidly that it can damage the quality of the dope and the stability in sending the dope. If the temperature T3 is higher than (T+30)° C., the elongated cooling time could not take effect.

In a case where the dope 18 obtained by compressing the stock solution 15 already has a set solubility and is sufficiently homogenous, the cooler 12 may be omitted from the dope producing apparatus 10 of the present invention.

[Heating Process]

The dope 18 is fed to the heater 13 that is connected to a downstream side of the cooler 12, to raise the dope temperature rapidly. By heating the dope 18, the solubility is promoted, so the homogeneity of the dope 18 is further improved. Besides, fluidity of the dope 18 rises up to facilitate sending the dope 18. The heating conditions of the dope 18 by the heater 13 are not restricted especially. However, the heating speed is preferably at least 20° C./min, more preferably at least 30° C./min, and most preferably at least 40° C./min. Further, the heating period is preferably at most 60 minutes, more preferably at most 30 minutes, and most preferably at most 10 minutes.

The produced dope 18 may be subjected to necessary processing, such as a density adjustment (condensation or dilution), a filtration, a temperature adjustment, an addition of components. The components to be added are determined depending on the use of the dope. The representative additives are plasticizers, deterioration inhibitor (for example peroxide decomposer, radical inhibitor, metal deactivator, acid capture, and the like), dye, and the UV-absorbing agent. It is necessary to preserve the dope in a temperature range preferable for stability of the dope. For example, when the dope is prepared in the cool-dissolving method from cellulose triacetate and methyl acetate as the main solvent, there are two phase-separation ranges in a high temperature area and a low temperature area of the practical preservation temperature range. In order to keep the dope stably, it is necessary to keep the temperature of the dope in an intermediate homogeneous phase range (e.g. 7° C. to 40° C.) between the higher and lower separation ranges. This temperature is in the constant phase region. The obtained dope is used in several ways. For example, the dope is fed to the film production apparatus to produce a film in a solution casting method.

[Solution Casting Method]

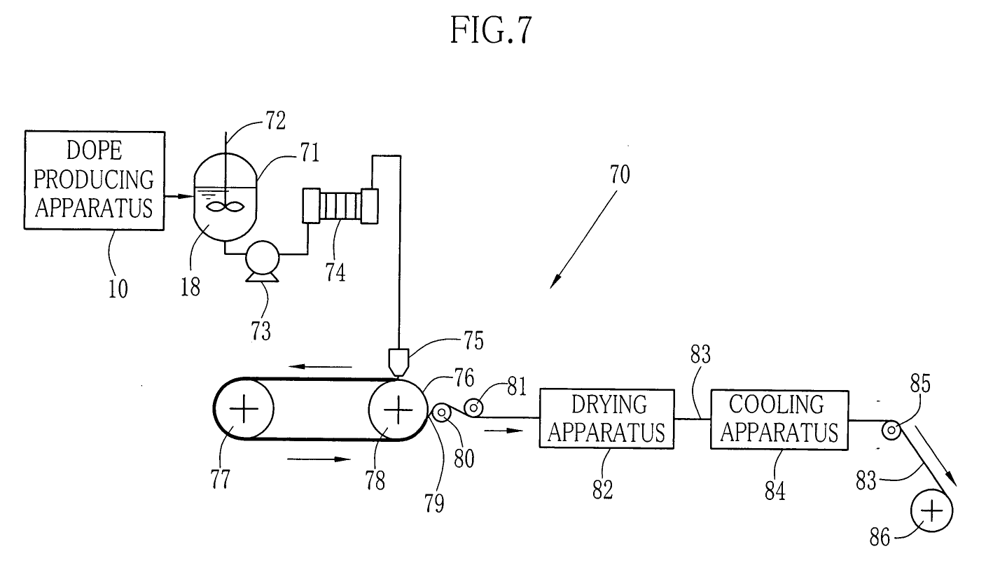

The production of the film from the above dope in the solution casting method will be explained. FIG. 7 illustrates a schematic view of a film production apparatus 70 used in the present invention. Note that in this embodiment the polymer used for the dope is cellulose acylate. However, the polymer used in the present invention is not restricted to cellulose acylate. The dope 18 obtained in the above-described method of producing the dope is contained in a mixing tank 71. The mixing tank 71 is provided with a stirrer 72, which rotates to stir the dope 18 for homogenization. Thereby, the additives may be added to the dope 18. The content of the solid material for the dope 18 is preferably in the range of 10 wt % to 30 wt %. The dope 18 is fed to a filtration device 74 at a constant flow rate by a pump 73, to eliminate impurities. Thereafter the dope 18 is fed to a casting die 75. Note that the filtration device 74 may be omitted in the present invention.

The dope 18 is cast from the casting die 75 onto a belt 76. Note that the temperature of the dope 18 thereby is preferably in the range of −50° C. to 80° C. However, the present invention is not restricted in it. The casting belt 76 is supported by rollers 77 and 78, and a driving device is driven to move the casting belt 76 cyclically and endlessly. The casting speed (or the moving speed of the casting belt 76) is preferably in the range of 0.5 m/s to 2 m/s, to obtain the film with a constant thickness. However, the present invention is not restricted in this range. The solvent gradually evaporates from the dope 18 as cast on the casting belt 76, so the dope 18 becomes a film having self-supporting properties, hereinafter called a wet film 79. Note that the surface of the casting belt 76 preferably has a mirror finished surface. Furthermore, instead of the casting belt 76 a rotary casting drum may be used.

The film 79 is peeled from the casting belt 76 with use of a peeling roller 80, and conveyed to a drying device 82 by rollers 81. As for the drying conditions of the drying device 82, it is preferable that the drying temperature is from 100° C. to 160° C., and that the drying period is from 5 minutes to 20 minutes. However, the present invention is not restricted to these temperature ranges. Through the drying device 82, the wet film 79 gradually becomes a film 83 whose solvent content is reduced desirably. It is preferable to provide plural sections in the drying device 72, so as to adjust the drying conditions depending on the content of the solvent in the film 69. The drying device 82 can be a tenter-type dryer, which enables applying an extension force to the wet film 79 in a widthwise direction to the casting direction. It is also possible to apply a drawing force to the wet film 79 in the conveying direction, i.e., the lengthwise direction, while the wet film 79 is being conveyed before being dried.

Preferably, the film 83 is fed to a cooler 84 to cool it after the drying device 82. In this case, the film does not deformed when the film is wound. However, the cooler 84 may be omitted. Note that it is preferable to cool the film to the room temperature in the cooler 84, but the temperature is not limitative. The film 83 discharged from the cooler 84 is conveyed by a roller 85 and wound up by a winding device 86. Note that a knurling, a cutting treatment of film side edges, or a treatment for adjusting electrification of the film 83 may be made while the film 83 is being conveyed from the cooler 84 to the winding device 86.

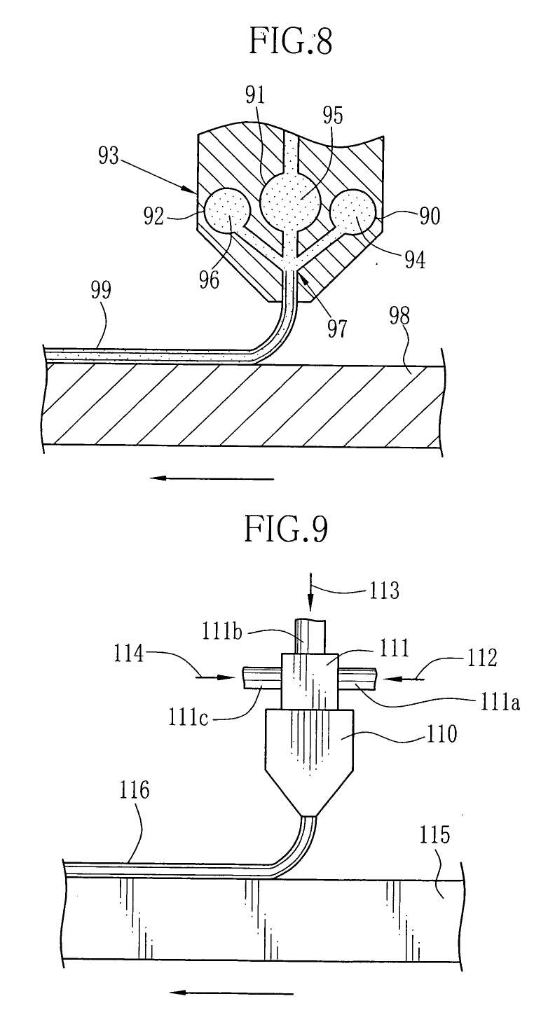

The solution casting method as a film production method of the present invention is not restricted to the above method. Other embodiments, especially those casting methods for forming multi-layered film will be explained with reference to FIGS. 8 to 10. Note that only the different points are explained in these figures, and the explanation for the same points as the above embodiment will be omitted.

FIG. 8 is a sectional view of a casting die 93 of a multi-manifold type used in a co-casting method as the method of producing the film. The casting die 93 has manifolds 90, 91 and 92, into which dopes 94, 95 and 96 are supplied. (Pipes for supplying the dopes are not shown). The dopes 94 to 96 are joined at a joining point 97, and cast on a casting belt 98 to form a cast film 99. The cast film 99 is peeled off as a wet film. The wet film is then dried to complete the film. The obtained film will have superior optical properties when at least one of the dopes supplied into the multi-manifold casting die 93 of FIG. 8 is produced according to the present invention. Most preferably, all the three dopes 94, 95 and 96 are the dopes produced according to the present invention.

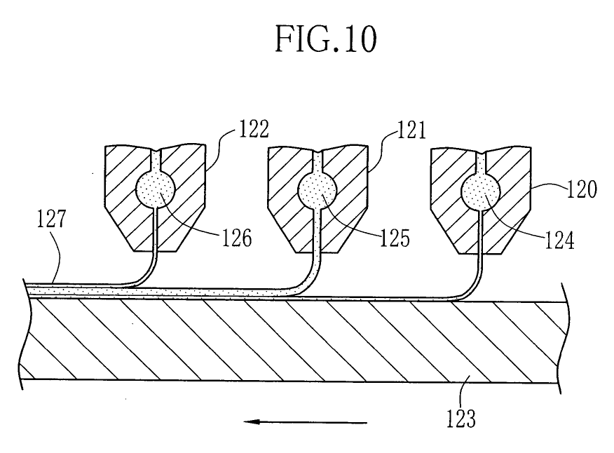

FIG. 9 is a side view of another embodiment of the co-casting. A feed block 111 is attached to casting die 110 in an upstream side thereof. Pipes 111a, 111b and 111c connect a dope feeding device (not shown) to the feed block 111 so as to feed dopes 112, 113 and 114. The dopes 112 to 114 are joined in the feed block 111, supplied into the casting die 110, and cast to form a cast film 116 on a casting belt 115. After having the self-supporting properties, the cast film 116 is peeled from the casting belt 115 and dried to obtain the film. The obtained film will have superior optical properties when the dope produced in the apparatus and the method of producing the dope of the present invention is used as at least one of the dopes supplied into the casting die 110. Especially preferably, all the three dopes 112 to 114 are the dopes produced in the apparatus and the method of producing the dope of the present invention. FIG. 10 is an exploded sectional view of an embodiment of the sequential casting. Three casting dies 120, 121 and 122 are disposed above a casting belt 123. Feeding devices (not shown) supply dopes 124, 125 and 126 to the respective casting dies 110 to 112. The dopes 124 to 126 are cast on the belt 113 sequentially to form a cast film 127. After the cast film 127 gets the self-supporting properties, it is peeled off the casting belt 123 as the wet film, and dried to obtain the film. The obtained film will have superior optical properties when the dope produced according to the present invention is used as at least one of the dopes. Especially preferably, all the three dopes 124 to 126 are the dopes produced according to the present invention.

As another embodiment than the above ones, for example, a method using a rotary drum as the substrate may be applicable. The solution casting method of the present invention may also include a hyper cooling casting method in which a rotary drum is cooled. Further, in the sequential casting method illustrated in FIG. 10, the casting die of the multi-manifold type may be used. It is also possible to apply a sequential co-casting method where a feed block is mounted on an upstream side of a casting die.

[Films]

The film obtained in one of the embodiments of the solution casting method is excellent in uniformity of film thickness and optical properties, since the dope is uniform. So the film is preferably usable as a protective film excellent in optical properties. Further, when the protective films are adhered to both surfaces of a polarized film containing polarizers therein, a polarizing plate with excellent optical properties is produced. An antireflection film may also be produced by forming antiglare layers on the film. These film products, such as the polarizing plate and an optical compensation film, can constitute a part of a liquid crystal display. Furthermore, a photosensitive material may be manufactured by forming photosensitive layers on the film.

### EXAMPLES

Now the present invention will be described in detail with reference to Examples, but the present invention is not to be limited to these Examples. The explanations of the embodiments will be made in detail about Experiment, and the same explanations will be omitted with respect to Experiments 2-12. Conditions and results of Experiments will be shown in Table 1.

[Experiment 1]

(Production of Dope)

In any experiments, the Dope 18 was prepared according to the following prescription:

| | | |
|---|---|---|
| Cellulose triacetate (acetyl value was 2.83, viscometric | 28 | pts. wt. |
| average degree of polymerization was 320, moisture | | |
| content was 0.4% by mass, viscosity of 6% by mass of | | |
| methylene chloride solution was 305 mPa · s) | | |
| Methyl acetate | 75 | pts. wt. |
| Cyclopentanone | 10 | pts. wt. |
| Acetone | 5 | pts. wt. |
| Methanol | 5 | pts. wt. |
| Ethanol | 5 | pts. wt. |
| Plasticizer A(dipentaerythritholhexaacetate) | 1 | pts. wt. |
| Plasticizer B(Triphenyl phosphate; TPP) | 1 | pts. wt. |
| Particles(silica having diameter of 20 nm) | 0.1 | pts. wt. |
| UV-absorbing agent a (2,4-bis-(n-octylthio)-6-(4- | 0.1 | pts. wt. |
| hydroxy-3,5-di-tert-butylanylino)-1,3,5-triazine) | | |
| UV-absorbing agent b (2-(2′-hydroxy-3′,5′-di- | 0.1 | pts. wt. |
| tert-butylphenyl)-5-chlorobenzotriazol) | | |
| UV-absorbing agent c (2-(2′-hydroxy-3′,5′-di- | 0.1 | pts. wt. |
| tert-amilphenyl)-5-chlorobenzotriazol) | | |
| C₁₂H₂₅OCH₂CH₂O—P(═O)—(OK)² | 0.05 | pts. wt. |

Cool-solubility was determined by measuring change in filtration pressure in a quantitative evaluation method. The obtained dope is fed by a gear pump to a paper filter (Advantec #63LB) with a filtration area of 12.5 cm² to filter through it. Relationship between change in filtration pressure P(kg/cm²) with time and filtration amount V(kg/cm²) was measured, and an average depth filtration index Ks is calculated according to the following formula, wherein the average depth filtration index Ks were rounded off to integer, and Po represents initial filtration pressure (kg/cm²), n represents an exponential.
(P/Po)^{-2/3n+1}32 1−Ks·V

The solubility was valuated in ten grades: the solubility was 10 when Ks was not more than 25, the solubility was 9 when Ks was from 26 to 30, the solubility was 8 when Ks was from 31 to 35, the solubility was 7 when Ks was from 36 to 40, the solubility was 6 when Ks was from 41 to 45, the solubility was 5 when Ks was from 46 to 50, the solubility was 4 when Ks was from 51 to 55, the solubility was 3 when Ks was from 56 to 60, the solubility was 2 when Ks was from 61 to 65, the solubility was 1 when Ks was not less than 66. In the present invention, when the solubility was not more than 3, the example was determined to be defective.

The dope was produced by use of an extrusion machine with two screws 32 and 50, which compress the dope. The screws have a diameter D (mm) of 30 mm, the ratio (L/D) of their lead length L (mm) to the diameter D was 42. Concerning the pitches of the screws, the ratio (P1/D) of the pitch P1 (mm) to the diameter D was 1.50, the ratio (P7/D) of the pitch P7 (mm) to the diameter D was 0.75. A flight 31 had a groove depth d (mm) of 6 mm. As a cooling medium 19, Novec (trade name) was used and adjusted to −75° C. A cylinder 61 was made of SCM (chrome molybdenum steel). A drill jacket 63 was mounted around the cylinder. The screws 32 and 50 were in mesh with each other and rotated in the same direction at a peripheral velocity of 0.04 m/s. This example showed a heat transfer coefficient of 126 W/(m²·K). The dope 18 was produced at 0.2 kg/minute, wherein the dope exit temperature was −65° C., and the temperature distribution range was 1° C. The solubility was 5, so the obtained dope 18 was good.

[Experiment 2]

Two screws 32 and 50 having a diameter D (mm) of 65 mm and a ratio (L/D) of 52.5 were used. The ratio (P1/D) was 1.50, the ratio (P7/D) was 0.75. A flight 31 had a groove depth d (mm) of 12 mm. As a cooling medium 19, Novec (trade name) was used and adjusted to −85° C. A cylinder 61 was made of SCM. A drill jacket 63 was used. The screws 32 and 50 were in mesh with each other and rotated in the same direction at a peripheral velocity of 0.14 m/s. This example showed a heat transfer coefficient of 189 W/(m²·K). The dope 18 was produced at 2.6 kg/minute, wherein the dope exit temperature was −65° C., and the temperature distribution range was 1° C. The solubility was 6, so the obtained dope 18 was good.

[Experiment 3]

Two screws 32 and 50 having a diameter D (mm) of 180 mm and the ratio (L/D) of 70 were used. The ratio (P1/D) was 1.50, the ratio (P7/D) was 0.75. A flight 31 had a groove depth d (mm) of 37 mm. As a cooling medium 19, Novec (trade name) was used and adjusted to −85° C. A cylinder 61 was made of SCM. A drill jacket 63 was used. The screws 32 and 50 were in mesh with each other and rotated in the same direction at a peripheral velocity of 0.24 m/s. This example showed a heat transfer coefficient of 234 W/(m²·K). The dope 18 was produced at 35 kg/minute, wherein the dope exit temperature was −65° C., and the temperature distribution range was 1° C. The solubility was 6, so the obtained dope 18 was good.

[Experiment 4]

Two screws 32 and 50 having a diameter D (mm) of 180 mm and the ratio (L/D) of 70 were used. The screws were a straight type where the ratio (P/D) of the pitch P to the diameter D was 1.0. A flight 31 had a groove depth d (mm) of 37 mm. As a cooling medium 19, Novec (trade name) was used and adjusted to −85° C. A cylinder 61 was made of SCM. A drill jacket 63 was used. The screws 32 and 50 were in mesh with each other and rotated in the same direction at a peripheral velocity of 0.33 m/s. This example showed a heat transfer coefficient of 266 W/(m²·K). The dope 18 was produced at 35 kg/minute, wherein the dope exit temperature was −68° C., and the temperature distribution range was 1° C. The solubility was 5, so the obtained dope 18 was good.

[Experiment 5]

Two screws 32 and 50 having a diameter D (mm) of 180 mm and the ratio (L/D) of 70 were used. The screws were a straight type where the ratio (P/D) of the pitch P to the diameter D was 0.75. A flight 31 had a groove depth d (mm) of 37 mm. As a cooling medium 19, Novec (trade name) was used and adjusted to −85° C. A cylinder 61 was made of SCM. A drill jacket 63 was used. The screws 32 and 50 were in mesh with each other and rotated in the same direction at a peripheral velocity of 0.33 m/s. This example showed a heat transfer coefficient of 266 W/(m²·K). The dope 18 was produced at 35 kg/minute, wherein the dope exit temperature was −68° C., and the temperature distribution range was 1° C. The solubility was 7, so the obtained dope 18 was good.

[Experiment 6]

Two screws 32 and 50 having a diameter D (mm) of 30 mm and the ratio (L/D) of 42 were used. The ratio (P1/D) was 1.50, the ratio (P7/D) was 0.75. A flight 31 had a groove depth d (mm) of 6 mm. As a cooling medium 19, Novec (trade name) was used and set to −75° C. A cylinder 61 was made of SCM. A drill jacket 63 was used. The screws 32 and 50 were in mesh with each other and rotated in the same direction at a peripheral velocity of 0.04 m/s. This example showed a heat transfer coefficient of 126 W/(m²·K). The dope 18 was produced at 0.2 kg/minute, wherein the dope exit temperature was −65° C., and the temperature distribution range was 1° C. Furthermore, a cooling extrusion machine with two screws having the same structure as ones of the extrusion machine 11 was attached, as the cooler 12, to the downstream of the extrusion machine 11. The dope 18 had a temperature of −68° C. at the exit of the second extrusion machine. The solubility was 9, so the obtained dope 18 was very good.

[Experiment 7]

Two screws 32 and 50 having a diameter D (mm) of 30 mm and the ratio (L/D) of 42 were used. The ratio (P1/D) was 1.50, the ratio (P7/D) was 0.75. A flight 31 had a groove depth d (mm) of 6 mm. As a cooling medium 19, Novec (trade name) was used and set to −75° C. A cylinder 61 was made of SCM. A drill jacket 63 was used. The screws 32 and 50 were in mesh with each other and rotated in the same direction at a peripheral velocity of 0.04 m/s. This example showed a heat transfer coefficient of 126 W/(m²·K). The dope 18 was produced at 0.2 kg/minute, wherein the dope exit temperature was −65° C., and the temperature distribution range was 1° C. Furthermore, a double-pipe cooler 12 was attached to the downstream of the extrusion machine 11. A cooling medium for the double-pipe cooler 12 was set at a temperature of −65° C., and was conducted 10 minutes through the cooler 12. The solubility was 10, so the obtained dope 18 was very good.

[Experiment 8]

Two screws 32 and 50 having a diameter D (mm) of 30 mm and the ratio (L/D) of 42 were used. The ratio (P1/D) was 1.50, the ratio (P7/D) was 0.75. A flight 31 had a groove depth d (mm) of 6 mm. As a cooling medium 19, Novec (trade name) was used and set to −75° C. A cylinder 61 was made of SCM. A drill jacket 63 was used. A cooling medium 40 was fed into the screws 32 and 50, as show in FIG. 4. The cooling medium 40 was Novec (trade name), and was set to −75° C. The screws 32 and 50 were in mesh with each other and rotated in the same direction at a peripheral velocity of 0.04 m/s. This example showed a heat transfer coefficient of 126 W/(m²·K). The dope 18 was produced at 0.2 kg/minute, wherein the dope exit temperature was −65° C., and the temperature distribution range was less than 1° C. The solubility was 7, so the obtained dope 18 was good.

[Experiment 9]

A screw having a diameter D (mm) of 100 mm and the ratio (L/D) of 20 was used. The screw was a straight type where the ratio (P/D) of the pitch P to the diameter D was 1.0. A flight 31 had a groove depth d (mm) of 3 mm. As a cooling medium 19, Novec (trade name) was used and adjusted to −85° C. A cylinder 61 was made of SCM. A drill jacket 63 was used. The screw was rotated at a peripheral velocity of 0.29 m/s. This example showed a heat transfer coefficient of 203 W/(m²·K). The dope 18 was produced at 2.0 kg/minute, wherein the dope exit temperature was −65° C. at the minimum, and the temperature distribution range was 12° C. The solubility was 3.

[Experiment 10]

A screw having a diameter D (mm) of 350 mm and the ratio (L/D) of 40 was used. The screw was a straight type where the ratio (P/D) of the pitch P to the diameter D was 1.0. A flight 31 had a groove depth d (mm) of 3 mm. As a cooling medium 19, Novec (trade name) was used and adjusted to −85° C. A cylinder 61 was made of SCM. A drill jacket 63 was used. The screw was rotated at a peripheral velocity of 0.29 m/s. This example showed a heat transfer coefficient of 203 W/(m²·K). The dope 18 was produced at 30 kg/minute, wherein the dope exit temperature was −65° C., and the temperature distribution range was 12° C. The solubility was 3.

[Experiment 11]

Two screws 32 and 50 having a diameter D (mm) of 65 mm and the ratio (L/D) of 52.2 were used. The ratio (P1/D) was 1.50, the ratio (P7/D) was 0.75. A flight 31 had a groove depth d (mm) of 12 mm. As a cooling medium 19, Novec (trade name) was used and set to −85° C. A cylinder 61 was made of SCM. A drill jacket 63 was used. The screws 32 and 50 were in mesh with each other and rotated in different directions at a peripheral velocity of 0.14 m/s. This example showed a heat transfer coefficient of 160 W/(m²·K). The dope 18 was produced at 2.6 kg/minute, wherein the dope exit temperature was −65° C., and the temperature distribution range was 4° C. The solubility was 7, so the obtained dope 18 was good.

[Experiment 12]

As a comparative experiment, the dope was produced by use of a static mixer (SMX by Surzer Co.). The mixer had an internal diameter of 100 mm, and a length-to-diameter ratio was 10. Element number was 5. A gear pump was used in the mixer. The static mixer had a double-pipe structure, wherein a cooling medium were conducted through external pipes. The cooling medium was Novec (trade name) and was set at −85° C. Because of a pressure increase, solution sending was impossible.

TABLE 1

| | Experiment | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Screw Shaft Number | 2 | 2 | 2 | 2 | 2 | 2 | 2 | 2 | 1 | 1 | 2 | |
| Screw Diameter (mm) | 30 | 65 | 180 | 180 | 180 | 30 | 30 | 30 | 100 | 350 | 65 | |
| Rotational Direction | S | S | S | S | S | S | S | S | — | — | D | |
| of Screw Shafts | | | | | | | | | | | | |
| Screw Type | C | C | C | 1.0 | 0.75 | C | C | C | 1.0 | 1.0 | C | |
| Shaft Cooling | — | — | — | — | — | — | — | O | — | — | — | |
| Cooler | — | — | — | — | — | O1 | O2 | — | — | — | — | — |
| Production Flow Rate | 0.2 | 2.6 | 35 | 35 | 35 | 0.2 | 0.2 | 0.2 | 2.0 | 30 | 2.6 | — |
| (kg/minute) | | | | | | | | | | | | |
| Temperature | 1 | 1 | 1 | 1 | 1 | 1 | 1 | <1 | 12 | 12 | 4 | 20 |
| Distribution (° C.) | | | | | | | | | | | | |
| Solubility | 5 | 6 | 6 | 5 | 7 | 9 | 10 | 7 | 3 | 3 | 4 | |

Rotational direction of screw shafts: S = same, D = different
Screw type: C = compressing type, others are straight types
Shaft cooling: O = YES, — = NO
Cooler: O1 = screw extrusion machine, O2 = double-pipe cooler

In Table 1, the results of Experiments 1 to 3 show that the solubility is promoted by increasing the production flow rate, which is considered to be effected by the peripheral velocity increase. From comparison between Experiment 2 and Experiment 9, it is seen that using twin-shaft screws makes the dope exit temperature approximately equal and improves the solubility of the solutes such as polymers. Experiments 3 and 4 show that compressing type screws are effective to promote the solubility. Experiments 4 and 5 show that the solubility is improved with regard to the straight type screw as the ratio of the screw pitch to the screw diameter gets smaller (from 1.0 to 0.75).

From Experiments 1, 6 and 7, it is seen that the dope will get excellent solubility by attaching the cooler 12 to the downstream of the extrusion machine 11. Experiments 1 and 8 shows that the solubility is improved by cooling the inside of the screws of the extrusion machine 11. Comparison between Experiments 1 to 3 and Experiments 9 and 10 shows that the solubility is not improved by increasing the screw size with regard to the single screw extrusion machine. Furthermore, from Experiments 2 and 11, it is seen that the solubility is improved by rotating the twin-shaft screws in the same direction more than the different or opposite direction, because the rotation in the same direction gives more shearing to the stock solution 15 than in the different direction.

Although the present invention has been described with respect to the preferred embodiments, the present invention is not to be limited to the above embodiments, but may be applicable to any cases where a hard-soluble solute should be dissolved in a solvent to produce a solution.

Thus, various changes and modifications are possible in the present invention and may be understood to be within the present invention.

What is claimed is:

1. A dope producing apparatus for producing a dope by sending materials of said dope through an extrusion machine, said extrusion machine comprising:
a cylinder to which said materials are supplied through an entrance, said dope being sent out from an exit of said cylinder;
a multi-shaft screw device comprising a number of screws, each of said screws being rotatably disposed in said cylinder; and
a first cooling device for cooling said materials.

2. A dope producing apparatus as defined in claim 1, wherein said multi-shaft screw device comprises two screws.

3. A dope producing apparatus as defined in claim 2, wherein said two screws are in mesh with each other and rotated in the same direction.

4. A dope producing apparatus as defined in claim 1, wherein each of said screws has a pitch P(mm) that is at a ratio (P/D) of 0.3 to 1.5 relative to its diameter D(mm).

5. A dope producing apparatus as defined in claim 4, wherein the ratio (P/D) of the pitch P to the diameter D decreases in a solution sending direction from the entrance toward the exit of said cylinder.

6. A dope producing apparatus as defined in claim 1, wherein said first cooling device is a jacket provided on a periphery of said cylinder of said extrusion machine, a cooling medium being supplied into said jacket.

7. A dope producing apparatus as defined in claim 6, wherein said jacket is divided into at least two sections in said solution sending direction.

8. A dope producing apparatus as defined in claim 1, further comprising a second cooling device for cooling said screws.

9. A dope producing apparatus as defined in claim 8, wherein said second cooling device comprises cooling medium conducting channels formed through a shaft of each of said screws and a device for supplying a cooling medium to said cooling medium conducting channels.

10. A dope producing apparatus as defined in claim 8, wherein at least one of said first and second cooling devices comprises a dual freezer that cools the cooling medium.

11. A dope producing apparatus as defined in claim 1, further comprising a third cooling device for cooling said dope on a downstream side of said extrusion machine.

12. A dope producing apparatus as defined in claim 11, further comprising a heating device for heating said dope on a downstream side of said third cooling device.

13. A dope producing apparatus as defined in claim 11, wherein said cooling mediums used in said first to third cooling devices are at least one of methanol, dichloromethane, hydro-fluoro-ether and fluorocarbon.

14. A dope producing apparatus as defined in claim 1, further comprising a volumetric feeder disposed at the entrance of said cylinder of said extrusion machine, for supplying a mixture of said materials by a constant amount.

15. A dope producing apparatus as defined in claim 1, further comprising a pressure control valve connected to the entrance of said cylinder of said extrusion machine, for controlling pressure of said materials as supplied into said extrusion machine.

16. A method of producing a dope, said method comprising steps of:
feeding materials of said dope, including a polymer and a solvent, to an extrusion machine having a plurality of screws;
compressing said materials or said dope by said screws; and
cooling said materials or said dope while being sent through said extrusion machine.

17. A dope producing method as defined in claim 16, wherein compression of said materials or said dope is done by decreasing pitches P (mm) of each of said screws in a solution sending direction through said extrusion machine.

18. A dope producing method as defined in claim 16, wherein said screws are two screws which are in mesh with each other and rotated in the same direction.

19. A dope producing method as defined in claim 16, wherein said materials or said dope is cooled at a cooling speed of 5° C./minute to 200° C./minute.

20. A dope producing method as defined in claim 16, wherein said materials or said dope is cooled so as to extrude said dope from said extrusion machine at a temperature of −30° C. or less.

21. A dope producing method as defined in claim 16, wherein said materials or said dope is cooled by supplying a cooling medium into a jacket that is provided on a periphery of a cylinder of said extrusion machine.

22. A dope producing method as defined in claim 21, wherein said jacket is divided into at least two sections in said solution sending direction, and said cooling medium is set at a first temperature T1(° C.) on an upstream side and at a second temperature T2(° C.) on a downstream side in said solution sending direction, wherein T2<T1.

23. A dope producing method as defined in claim 16, wherein said materials or said dope is cooled by cooling said screws.

24. A dope producing method as defined in claim 16, further comprising a step of cooling said dope further in a cooler after said dope is extruded from said extrusion machine.

25. A dope producing method as defined in claim 24, wherein said dope is cooled in said cooler at most for 60 minutes.

26. A dope producing method as defined in claim 24, wherein said cooler is supplied with a cooling medium whose temperature T3(° C.) is defined to satisfy the following condition relative to a temperature T(° C.) of said dope at an exit of said extrusion machine: T−30° C.≦T2≦T+30° C.

27. A dope producing method as defined in claim 16, wherein said materials or said dope is cooled by cooling said extrusion machine with use of a cooling medium that is at least one of methanol, dichloromethane, hydro-fluoro-ether and fluorocarbon.

28. A dope producing method as defined in claim 26, wherein said cooling medium for said cooler is at least one of methanol, dichloromethane, hydro-fluoro-ether and fluorocarbon.

29. A dope producing method as defined in claim 26, further comprising a step of heating said dope at a heating speed of at least 20° C./minute, after said dope is cooled in said extrusion machine or in said cooler.

30. A dope producing method as defined in claim 16, wherein said polymer is cellulose acylate.

31. A dope producing method as defined in claim 16, wherein said solvent includes at least methyl acetate.
